(19) United States
(12) Patent Application Publication
(10) Pub. No.: US 2026/0365407 A1
(43) Pub. Date: Nov. 19, 2026

(54) CONTROLLED MOISTURE TRANSPORT PACKAGING FOR FRESH PRODUCE

(71) Applicant: Windham Packaging, LLC, Windham, NH (US)

(72) Inventor: Elizabeth Varriano-Marston, Windham, NH (US)

(73) Assignee: Windham Packaging, LLC, Windham, NH (US)

(21) Appl. No.: 19/741,406

(22) Filed: Jul. 14, 2026

Related U.S. Application Data
(63) Continuation-in-part of application No. 18/117,807, filed on Mar. 6, 2023.
(60) Provisional application No. 63/394,688, filed on Aug. 3, 2022.

(51) Int. Cl. B65D 81/20; B31B 70/81; B31B 70/83; B65D 65/40; B65D 81/22; B65D 85/50

(52) U.S. Cl. CPC B65D 81/2084; B31B 70/8122; B31B 70/83; B65D 65/40; B65D 81/22; B65D 85/50

(57) ABSTRACT

A method of containing fresh produce comprises estimating a moisture production rate of the produce and containing the produce in a container having a net moisture transport equal to the estimated moisture production rate. At least one wall of the container includes a film comprising a first low water vapor transport rate (WVTR) layer laminated to a second high WVTR layer, the laminated film comprising moisture transport windows (MTWs) created by cutting and removing panels of the first layer from window areas where the layers are not bonded together. The window areas can be formed by spraying the laminating adhesive through a mask or applying the adhesive using a roller assembly with insets. A heat and/or pressure activated adhesive can be uniformly applied, with pressure and/or heat being withheld from the window areas. The film can be heat-sealed to a tray. Micro-perforations can establish a modified gas atmosphere.

### RELATED APPLICATIONS

This application is a continuation in part of U.S. application Ser. No. 18/117,807, filed on Mar. 6, 2023. Application Ser. No. 18/117,807 claims the benefit of U.S. Provisional Application No. 63/394,688, filed Aug. 3, 2022. Both of these applications are incorporated by reference in their entirety for all purposes.

### FIELD OF THE INVENTION

The invention relates to packaging, and more particularly, to packaging of fresh produce.

### BACKGROUND OF THE INVENTION

Container designs for fresh produce face many challenges, because they must enable produce to remain alive and fresh within the container for as long as possible. In most cases, packaging that is tightly gas-sealed will suffocate the produce, and lead to its early demise and spoilage. For some types of produce that are whole or have a protective skin that retains moisture, such as apples and oranges, a “ventilated” packaging, may be the preferred option, whereby the atmosphere surrounding the produce is maintained close to ambient conditions, both in terms of O₂ content and humidity.

With reference to FIG. 1A, for fresh produce 102 that has a high respiration rate and a relatively low release of water vapor during storage, such as bananas and broccoli, improved freshness retention can be provided by establishing a “modified atmosphere” within the container 100. One approach to “modified atmosphere packaging” (MAP) is to provide microperforations 104 through an otherwise gas-sealed container 100, thereby permitting only a limited O₂ and CO₂ exchange rate between the interior of the container 100 and the environment. Under these conditions, the respiration of the produce results in a modified atmosphere within the container having a reduced O₂ concentration and increased CO₂ concentration as compared to ambient. This modified atmosphere slows the respiration rate of the produce 102 without causing rapid quality deterioration, thereby keeping it fresh longer than would be the case for ventilated packaging.

However, many packaging materials used for MAP packaging are substantially impermeable to moisture. With reference to FIG. 1B, for produce having a high moisture production rate 106, such as whole cucumbers and peppers for example, a lack of moisture exchange with the environment can lead to pooling of excess moisture 108 within the container 100, thereby causing the produce 106 to rapidly spoil. On the other hand, too much moisture exchange, for example due to ventilated packaging, can cause the produce to dry out, i.e. become desiccated, thereby quickly reducing its freshness and consumer acceptability.

What is needed, therefore, is a fresh produce packaging solution that prevents produce having a high moisture production rate from being prematurely desiccated, while at the same time preventing any pooling of excess moisture within the container.

### SUMMARY OF THE INVENTION

The present invention is a fresh produce packaging solution that prevents produce having a high moisture production rate from being prematurely desiccated, while at the same time limiting or preventing any pooling of excess moisture within the container.

The disclosed fresh produce container includes a laminate polymer film that substantially prevents gas exchange with the environment, while permitting a limited transport of moisture into the environment that is approximately equal to a rate at which moisture is produced by the fresh produce within the container when the container is at ambient temperature, for example at a storage temperature of not more than 25 °C. This allows produce having a high moisture production rate, such as cucumbers and peppers, to establish a moisture-controlled environment (MCE) within the container that avoids desiccation of the produce, while at the same time allowing a sufficient water vapor transport to avoid pooling of excess moisture within the container. For this reason, the disclosed container is sometimes referred to herein as the “MCE” container.

At least one wall of the disclosed fresh produce container includes a laminate polymer film that includes a first film layer, such as a polyethylene terephthalate (PET) film layer, having a water vapor transport rate “WVTR,” also sometimes referred to as the moisture vapor transport rate, “MVTR,” which is not more than 70 g-mil/m²-day @38 °C and 100% RH, where “RH” refers to relative humidity.

The first film layer is laminated to a second film layer, such as a nylon, polylactic acid (PLA) or cellulose, that is also substantially impermeable to gases, but has a much higher WVTR than the first film layer. The O₂ transfer rate of the second film layer is not more than 70 cc-mil O₂/m² day at 23 °C and 0% RH, while the water vapor transport rate (WVTR) of the second film layer is between 250 and 700 g-mil/m²-day at 38 °C and 100% RH.

The high WVTR of the second film layer arises from a molecular attraction between the polymer and water molecules, which draws excess moisture into the polymer, and upon saturation thereof allows some of the moisture to escape into the ambient environment. Gases such as O₂ and CO₂ have low transmission rates through the second film layer, because they do not experience a similar molecular attraction to the polymer.

Gaps or openings are provided in the first film layer of the laminate film, thereby creating moisture transport windows (MTWs) where only the second film layer is present, but not the first film layer. By controlling the number and sizes of these MTWs, the net rate of moisture transport through the laminate film, and thereby through the container, can be controlled, such that it is substantially equal to the moisture production rate of the fresh produce that is contained within the container. The MTWs are responsible for a majority of the moisture transport through the laminate film, where the net rate of moisture transport through each of the MTWs is equal to the WVTR of the second film layer multiplied by the area of the MTW and divided by the thickness of the second film layer.

Each of the MTWs occupies at least 1% of the total area of the laminate film, while the combined area of all of the MTWs occupies between 10% and 90% of the total area of the laminate film.

At least one wall of the disclosed container can be penetrated by microperforations that provide a limited O₂ and CO₂ gas exchange with the environment, thereby creating a modified gaseous atmosphere within the container. These embodiments are referred to herein as Moisture Controlled Environment-Modified Atmosphere (MCE-MAP) containers.

In some embodiments, the disclosed MCE container is formed entirely by the laminate film, thereby providing a flexible bag or pouch. In other embodiments, the laminate film is applied as a lidding film to a rigid or semi-rigid container or tray made from a material that is substantially impermeable to both gases and water vapor. In embodiments, the WVTR of the material from which the container or tray is constructed is less than 40 g-mil/m²-day at 38 °C and 100% RH. For example, the container or tray can be constructed from PET having a thickness of about 18 to 20 mil. In some of these embodiments, a flange is provided at the upper rim of the tray, and the laminate film is heat sealed to the flange. In other embodiments, an adhesive is applied to the laminate film in an adhesive pattern that is configured such that the adhesive will be applied to the flange of the tray, but will not encroach into any region that is accessible to the contents of the container. In similar embodiments, the adhesive is applied to the flange of the tray before the laminate film as applied thereto.

In some embodiments where the container is a pouch formed entirely from the laminate film, and an adhesive is applied to the film in an adhesive pattern that is configured to enable seam regions of the laminate film to attach to each other in a manner that forms the pouch.

Also disclosed herein is a method of designing and manufacturing the disclosed MCE container. Designing the MCE container comprises specifying a type and quantity of fresh produce to be contained, estimating a moisture production rate of the fresh produce, and determining the number and associated sizes of the MTWs that will cause the net rate of moisture transport out of the container when at a storage temperature of not more than 25 °C, to be substantially equal to the moisture production rate of the intended contents.

According to the disclosure, the MTWs are formed in the laminate film before the film is incorporated into the MCE container. In some embodiments, the first and second film layers are adhesively laminated to each other. In some of these embodiments, the adhesive is sprayed onto one of the two layers through a mask that prevents the adhesive from being applied to designated window areas. In other of these embodiments, the adhesive to one of the layers by an adhesive-applying roller assembly, which can or a roller assembly comprising a magnetic, adhesive-applying plate that is wrapped around and magnetically adhered to a roller. It will be understood that the term “roller assembly” is sometimes used herein to refer generically to either a roller having the specified features or a conventional roller surrounded by a plate having the specified features and magnetically attached to the roller.

The adhesive-applying roller assembly includes insets that prevent the adhesive from being applied to the designated window areas. Once the adhesive has been applied, the two film layers are pressed together (laminated), for example by a pair of pressing or nip rollers.

In still other embodiments, a pressure and/or heat sensitive adhesive is applied uniformly to one of the film layers, after which the layers are pressed together by a pair of roller assemblies that include corresponding inset and/or unheated regions that create window areas where the adhesive is not activated. For these embodiments, the adhesive used must not interfere with the moisture transfer rate of the second film layer. In similar embodiments, the film layers are heat-sealed directly to each other by a pair of roller assemblies that include unheated regions. As a result, the film layers are not bonded to each other in the regions that pass between the inset and/or unheated regions, thereby creating the required window areas.

After the two film layers have been laminated together, a device such as a laser or a mechanical die-cutting plate or roller assembly is used to cut out and remove panels of the first film layer from within the window areas, while leaving the second film layer intact throughout the laminate film. In the case of a laser, the laser process conditions are adjusted such that the cutting beam penetrates through the first film layer, but does not fully penetrate the second film layer. In the case of a mechanical die-cutting plate or roller assembly, the die-cutting edges or blades extend above the surface of the plate or roller assembly far enough to mechanically penetrate through the first film layer, but not far enough to penetrate completely through the second film layer. In embodiments, the window areas are slightly larger than the MTWs, thereby ensuring that no parts of the cut panels are adhered to the second film layer.

The MCE container of the present invention is then created by cutting out a section of the laminate film in an appropriate size and shape, and bonding selected regions or “seams” of the laminate film to each other, and/or to an underlying rigid or semi-rigid tray. In embodiments, the first film layer is made from a material such as PET that can be readily heat sealed, and the attachment of the “seams” of the laminate film is by heat sealing of the first film layer of the laminate film in the seam regions. In these embodiments, it is not necessary that the second film layer be readily heat sealable.

The present invention is a method of containing a determined type and quantity of fresh produce. The method includes estimating a rate of moisture production of the determined type and quantity of the fresh produce at a storage temperature that is not more than 25 °C, designing a moisture-controlled environment (MCE) container for which a net rate of moisture transport from the MCE container to a surrounding environment will be substantially equal to the estimated rate of moisture production of the determined type and quantity of the fresh produce when the MCE container and the determined type and quantity of the fresh produce are at the storage temperature, constructing the designed MCE container, and containing the determined type and quantity of the fresh produce in the constructed MCE container

At least one wall of the MCE container comprises a laminate film, which comprises a first film layer having a water vapor transport rate “WVTR” which is not more than 70 g-mil/m²-day @38 C and 100% RH, and a second film layer laminated to the first film layer, the second film layer having an O₂ transfer rate that is not more than 70 cc-mil O₂/m² day at 23 °C and 0% RH, and a WVTR that is between 250 and 700 g-mil/m²-day at 38 °C and 100% RH. The laminate film comprises at least one moisture transport window (MTW) in which only the second film layer is present, while the first film layer is absent.

Designing the MCE container comprises determining a number and associated sizes of the MTWs that will cause the net rate of moisture transport from the MCE container to the surrounding environment to be substantially equal to the estimated rate of moisture production of the determined type and quantity of the fresh produce when the MCE container and the fresh produce are at the storage temperature,

Each of the MTWs occupies at least 1% of a total area of the laminate film, and a combined area of all of the MTWs occupies between 10% and 90% of the total area of the laminate film. Constructing the MCE container comprises preparing the laminate film, including the at least one MTW, before incorporation thereof into the MCE container.

In embodiments, the first film layer is a layer of heat-sealable polyethylene terephthalate (PET) film.

In any of the above embodiments, the second film layer can be a layer of nylon, cellulose, or polylactic acid film.

In any of the above embodiments, the MCE container can be constructed by applying the laminate film as a lidding film to an underlying rigid or semi-rigid tray. In embodiments, the rigid or semi-rigid tray has a WVTR that is less than 40 g-mil/m2-day at 38 °C and 100% RH. In any of these embodiments, the attachment regions of the first film layer can be heat sealed to an upper flange of the underlying rigid or semi-rigid tray.

Or, all of the container walls can be formed by the laminate film. In some of these embodiments, the container is formed by heat sealing together the first film layer of the laminate film in seam regions of the laminate film.

Any of the above embodiments can further include determining a desired rate of gas exchange through the laminate film, and providing one or more microperforations of the laminate film, the microperforations being configured such that a modified gaseous atmosphere is established within the MCE container.

In any of the above embodiments, preparing the laminate film, including the at least one MTW, can include including at least one window area in the laminate film within which the first and second film layers are not bonded to each other, for each of the window areas, forming a cut through the first film layer that defines and surrounds a removable panel of the first film layer that is entirely within the window area, wherein forming the cut comprises directing a cutting device at the first film layer of the laminate film, the cutting device being configured to cut through the first film layer but not to cut completely through the second film layer, and for each of the window areas, removing the removable panel from the window area, thereby forming one of the at least one MTWs.

In some of these embodiments, preparing the laminate film comprises applying an adhesive to an adhesive-applying roller assembly having at least one inset, applying the adhesive-applying roller assembly to one of the first film layer and the second film layer before lamination together thereof, the adhesive not being applied to the at least one window area, and applying the first film layer to the second film layer, thereby causing the applied adhesive to bond together the first and second film layers to form the laminate film.

Or, preparing the laminate film comprises spraying an adhesive through a mask positioned above the first film layer or the second film layer before lamination together thereof, whereby the mask prevents the adhesive from being applied to the at least one window area, and applying the first film layer to the second film layer, thereby forming the laminate film causing the applied adhesive to bond together the first and second film layers except in the at least one window area.

Or, preparing the laminate film comprises applying a pressure-activated adhesive uniformly to at least one of the first film layer and the second film layer before lamination together thereof, mutually aligning the first film layer with the second film layer, and applying pressure to the aligned first and second film layers by passing the aligned first and second film layers between a pair of laminating roller assemblies, said laminating roller assemblies having insets that are configured not to apply the pressure to the window areas of the aligned first and second film layers.

Or, preparing the laminate film comprises applying a heat-activated adhesive uniformly to at least one of the first film layer and the second film layer before lamination together thereof, mutually aligning the first film layer with the second film layer, and applying heat to the aligned first and second film layers by passing the aligned first and second film layers between a pair of laminating roller assemblies, said laminating roller assemblies having unheated regions that are configured not to apply the heat to the window areas of the aligned first and second film layers.

In any of these embodiments, for each of the window areas, the cutting device can be a laser or a mechanical die-cutting plate, or a mechanical die-cutting roller assembly, which can comprise a conventional roller surrounded by a magnetically attached die-cutting plate.

In any of these embodiments, for each of the window areas, the removable panel can be removed at least partly by gravitational force, and/or at least partly by application of suction thereto.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a perspective view of a modified atmosphere container (MAP) of the prior art containing produce that has a low moisture production rate;

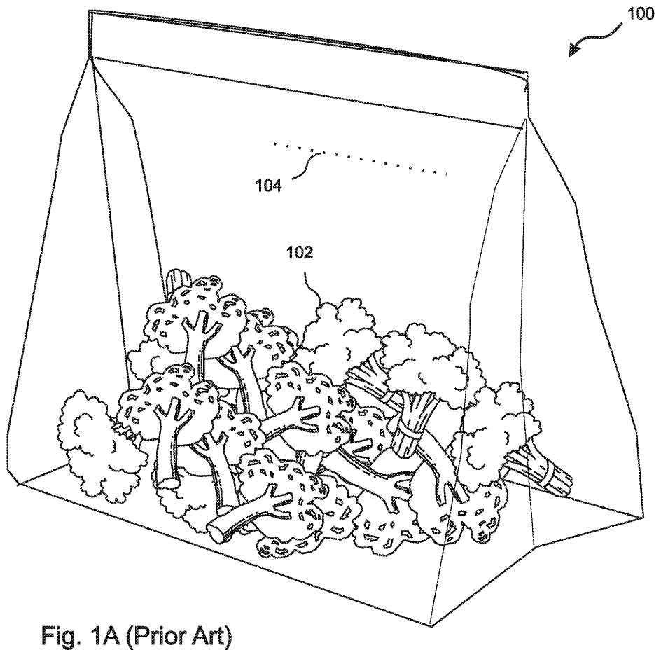

FIG. 1B is a perspective view of the container of FIG. 1A containing produce that has a high moisture production rate, in which moisture has pooled;

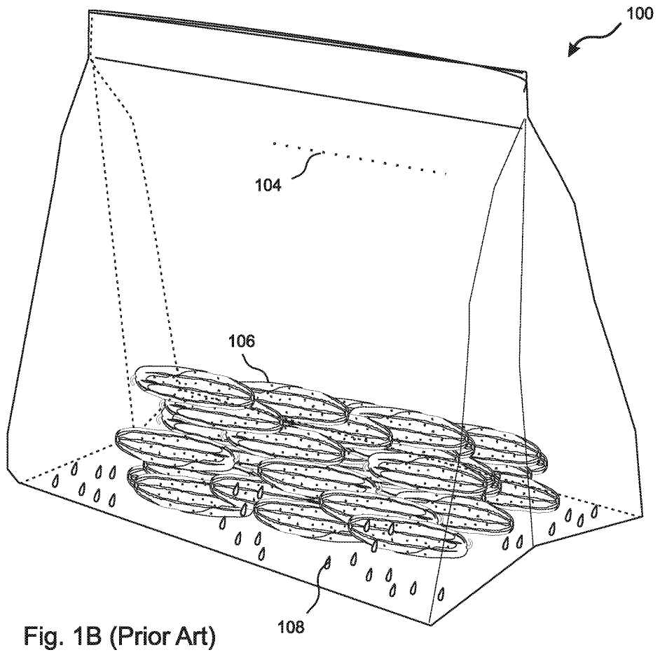

FIG. 2 is a perspective view of a container in an embodiment of the present invention that is a flexible pouch formed entirely of the disclosed laminate film, the container having separate moisture transport windows (MTWs) on the front and the back panels of the pouch;

FIG. 3A is a perspective view of a container or tray that has a flange, with the lidding film shown above the tray and prepared for heat-sealing to the flange;

FIG. 3B is a perspective view of the container of FIG. 3A showing the lidding film heat sealed to the tray;

FIG. 4A is a perspective view showing panels of the first and second film layers of the disclosed laminate film separated from each other before lamination in an embodiment of the present invention;

FIG. 4B is a perspective view showing the panels of FIG. 4A laminated to each other;

FIG. 5 is a perspective view that illustrates a method of manufacture of the present invention in which a mask is used to create lamination gaps in window areas of the laminate film;

FIG. 6 is a perspective view that illustrates a method of manufacture of the present invention in which the lamination gaps in the window areas of the laminate film are mechanically formed by a roller having insets;

FIG. 7 is a perspective view that illustrates a method of manufacture of the present invention in which the lamination gaps are mechanically formed in the window areas by applying a pressure activated adhesive and laminating the films using roller assemblies comprising conventional rollers to which magnetic plates having insets are attached;

FIG. 8 illustrates the use of a laser to create MTWs by cutting out panels in the lamination gaps from the first, low water vapor transport (WVTR) layer of the film but not through the second, high WVTR layer in an embodiment of the present invention;

FIG. 9 illustrates the use of a roller assembly comprising a conventional roller to which a magnetic die-cutting plate is attached to create MTWs by mechanically cutting out panels in the lamination gaps from the first, low water transport (WVTR) layer of the film but not through the second, high WVTR layer in an embodiment of the present invention;

FIG. 10A is a top view of a section of laminate film in an embodiment of the present invention shown after cutting panels in the lamination gaps from the first, low WVTR layer of the laminate film but before removal of the panels according to an embodiment of the present invention;

FIG. 10B is a perspective view of the section of FIG. 10A showing the cut-out panel partially peeled away from the lamination gap;

FIG. 11A is a top view drawn to scale of a section of laminate film according to an embodiment of the present invention that has been cut to shape in preparation for forming a fresh produce pouch; and

FIG. 11B is a perspective view of the container formed by the cut-out laminate film of FIG. 10A;

FIG. 11C is a top view, of drawn to scale, of an adhesive printing pattern used in an embodiment where the laminate film 202 is applied as a lidding film to a tray 302; and

FIG. 12 is a flow diagram that illustrates a method embodiment of the present invention.

### DETAILED DESCRIPTION

The present invention is a fresh produce packaging solution that prevents produce having a high moisture production rate from being prematurely desiccated, while at the same time limiting or preventing any pooling of excess moisture within the container.

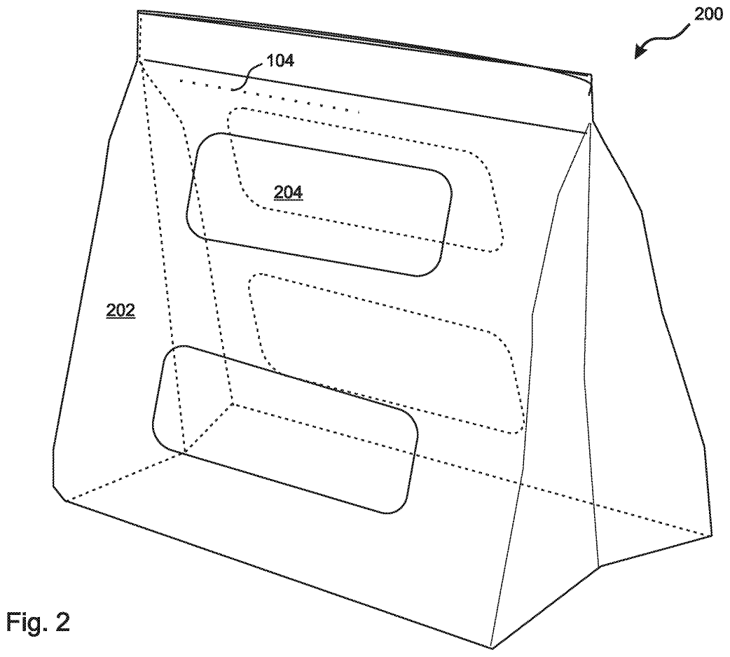

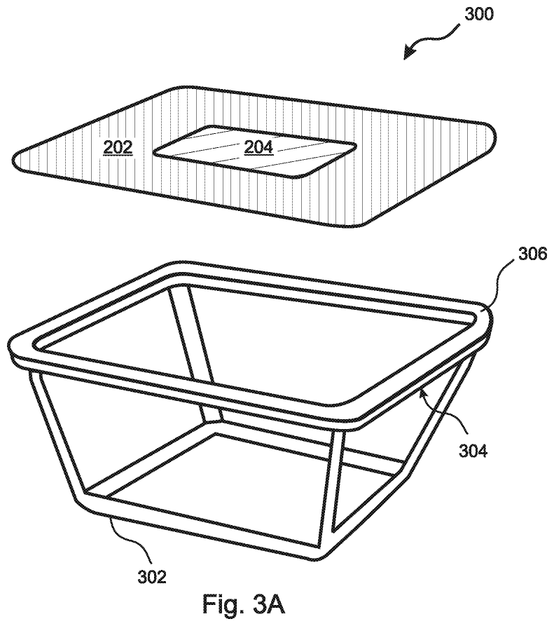

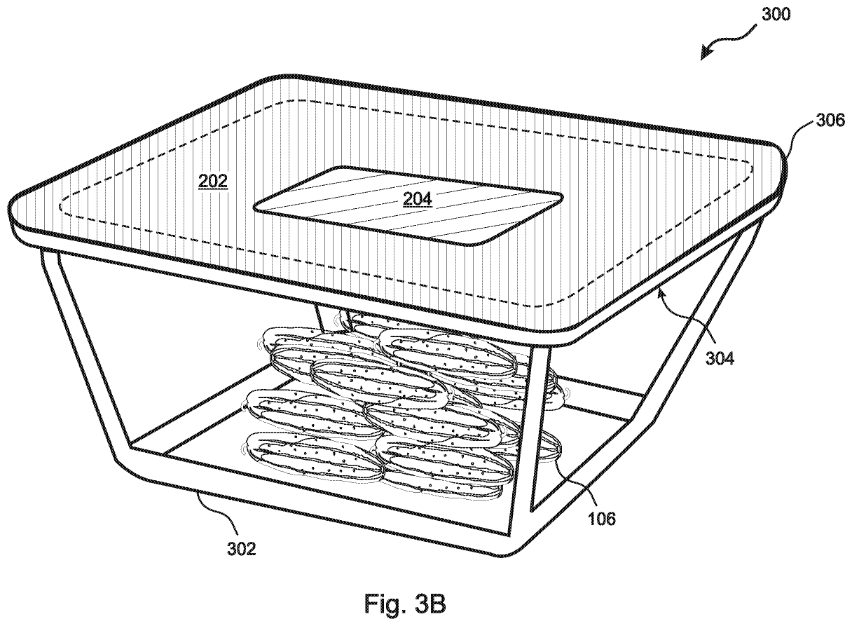

With reference to FIGS. 2 and 3, the disclosed container 200, 300 includes a laminate polymer film 202 in which moisture transport “windows” 204 (MTWs) are provided that permit a limited transport of moisture to the environment, while minimizing the O₂ and CO₂ gas exchange with the environment. This allows fresh produce 106 having a high rate of moisture production, such as cucumbers and peppers, to establish a moisture-controlled environment (MCE) within the container 200, 300 that avoids desiccation of the produce 106, while at the same time allowing a sufficient escape of moisture to avoid pooling of excess moisture 108 within the container 200, 300. In some embodiments, as illustrated in FIG. 2, the disclosed “MCE” packaging 200 is formed entirely by the laminate film 202, thereby providing a flexible bag or pouch 200.

In other embodiments, as illustrated in FIGS. 3A-3B, the container 300 is formed by applying the laminate film 202 as a lidding film to a rigid or semi-rigid container or tray 302 made from a material that is substantially impermeable to both gases and water vapor. In embodiments, the WVTR of the material from which the container or tray 302 is constructed is less than 40 g-mil/m²-day at 38 °C and 100% RH. For example, the container or tray 302 can be constructed from PET having a thickness of about 18 to 20 mil.

In the embodiment of FIGS. 3A and 3B, a flange 304 is provided at the upper rim of the tray 302, and the laminate film 202 is heat-sealed to the flange 304 of the tray 302, as shown in FIG. 3B. In similar embodiments, the laminate film 202 is attached to the tray 302 by an adhesive that is applied to the flange 304 in such a way that it does not encroach into any region of the MCE container 300 that is accessible to the contents 106 of the container 300.

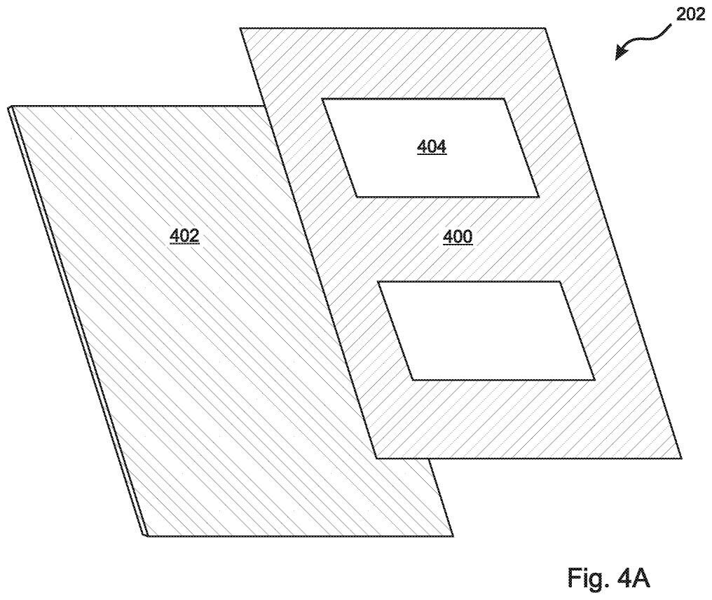

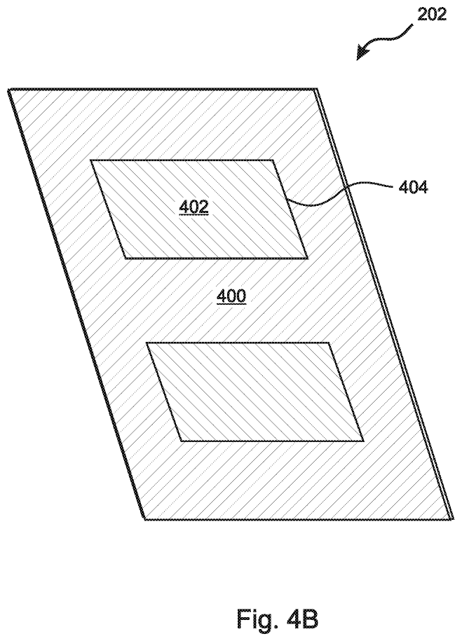

With reference to FIGS. 4A and 4B, the laminate polymer film 202 of the present invention includes a first film layer 400, such as a polyethylene terephthalate (PET) film layer, that is substantially impermeable to gases such as O₂ and CO₂, and has a water vapor transport rate “WVTR,” also sometimes referred to as the moisture vapor transport rate, “MVTR,” which is not more than 70 g-mil/m²-day @38 °C and 100% RH, where “RH” refers to relative humidity.

The first film layer 400 is laminated to a second film layer 402, such as a nylon, PLA or cellulose layer, that is also substantially impermeable to gases, but has a much higher WVTR than the first film layer. The O₂ transfer rate of the second film layer 402 is not more than 70 cc-mil O₂/m² day at 23 °C and 0% RH, while the water vapor transport rate (WVTR) of the second film layer 402 is between 250 and 700 g-mil/m²-day at 38 °C and 100% RH.

The high WVTR of the second film layer 402 arises from a molecular attraction between the polymer and water molecules, which draws excess moisture into the polymer, and upon saturation thereof allows some of the moisture to escape into the ambient environment. Only a limited amount of O₂ and CO₂ pass through the second film layer, because they do not experience a similar molecular attraction to the polymer as does the moisture vapor.

Gaps or openings are provided in the first film layer 400 of the laminate film 202, thereby creating moisture transport windows (MTWs) 404 where only the second film layer 402 is present, but not the first film layer 400. By controlling the number and sizes of these MTWs 404, the net rate of moisture transport through the laminate film 202, and thereby through the container 200, 300, can be controlled, such that it is substantially equal to the moisture production rate of the fresh produce 106 that is contained within the container 200, 300. The MTWs 404 are responsible for a majority of the moisture transport through the laminate film 202, where the net rate of moisture transport through each of the MTWs 404 is equal to the WVTR of the second film layer 402 multiplied by the area of the MTW 404 and divided by the thickness of the second film layer 402.

Each of the MTWs 404 occupies at least 1% of the total area of the laminate film 202, while the combined area of all of the MTWs 404 occupies between 10% and 90% of the total area of the laminate film 202.

At least one wall of the disclosed container 200, 300 can be penetrated by microperforations 104 that provide a limited O₂ and CO₂ gas exchange with the environment, thereby creating a modified gaseous atmosphere within the container 200. These embodiments are referred to herein as Moisture Controlled Environment-Modified Atmosphere (MCE-MAP) containers.

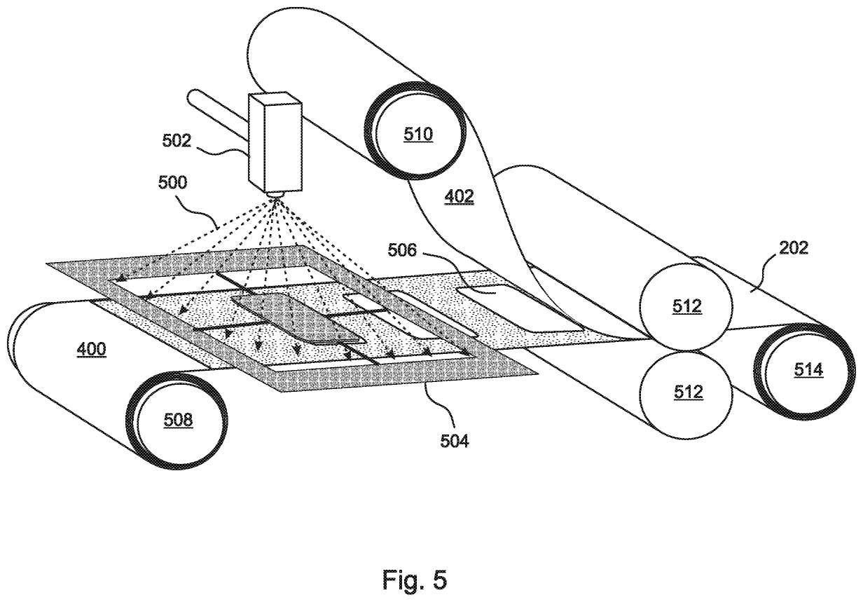

Also disclosed herein is a method of manufacture of the disclosed MCE container. In some embodiments the first 400 and second 402 film layers are adhesively laminated to each other. With reference to FIG. 5, in some of these embodiments, the laminating adhesive 500 is sprayed by an adhesive spraying device 502 onto one of the two film layers through a mask 504 that prevents the adhesive from being applied to designated window areas 506 of the film layer. In the illustrated embodiment, a first PET film layer 400 is fed from a first feed roller 508 under the mask 504 through which adhesive 500 is periodically sprayed, thereby applying the adhesive 500 to the first film layer 400 in a pattern that includes gaps 506 that define the window areas 506. In embodiments, the advance of the first film layer 400 is briefly stopped each time a spray of the adhesive is applied.

In the illustrated embodiment a second, high water transport layer 402, such as a nylon, PLA or cellulose film layer 402, is fed from a second feed roller 510 and bonded to the first film layer 400 by laminating rollers 512 that apply pressure and/or heat to bond the second film layer 402 to the first film layer 400. The resulting laminate film 202 is taken up by a receiving roller 514.

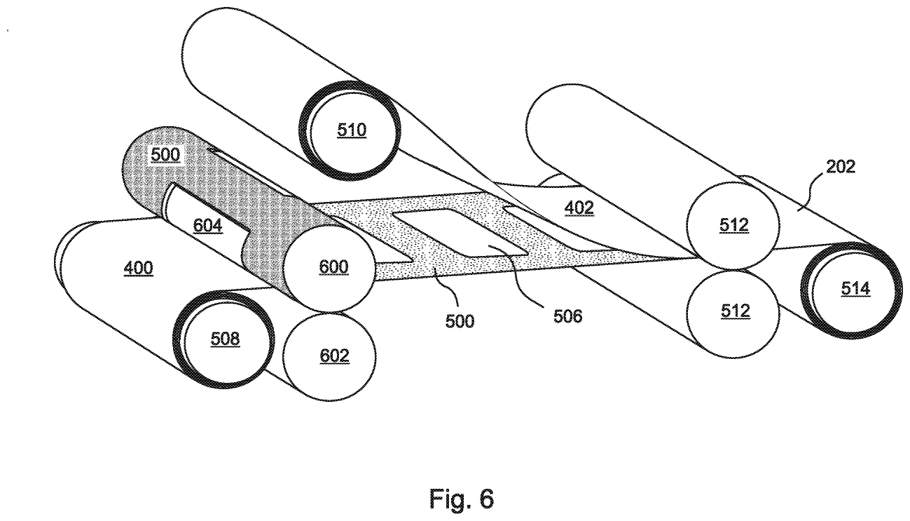

With reference to FIG. 6, in other embodiments one of the film layers passes through a pair of adhesive-applying rollers 600, 602, one of which 600 is coated by the adhesive 500, while the other roller 602 applies counter-pressure. The adhesive-coated roller 600 includes insets 604 that prevent the adhesive from being applied to the designated window areas of the film layer, which in the example of FIG. 6 is the PET first film layer 400. Once the adhesive 500 has been applied, the two film layers 400, 402 are pressed together to form the laminate film 202, as in FIG. 5. In similar embodiments, instead of an adhesive-coated roller 600, a roller assembly is used that comprises a conventional roller surrounded by an adhesive coated plate having insets that is magnetically attached to the roller. It will be understood that the term “roller assembly” is sometimes used herein to refer generically to either a roller having the specified features or a conventional roller surrounded by a plate having the specified features and magnetically attached to the roller.

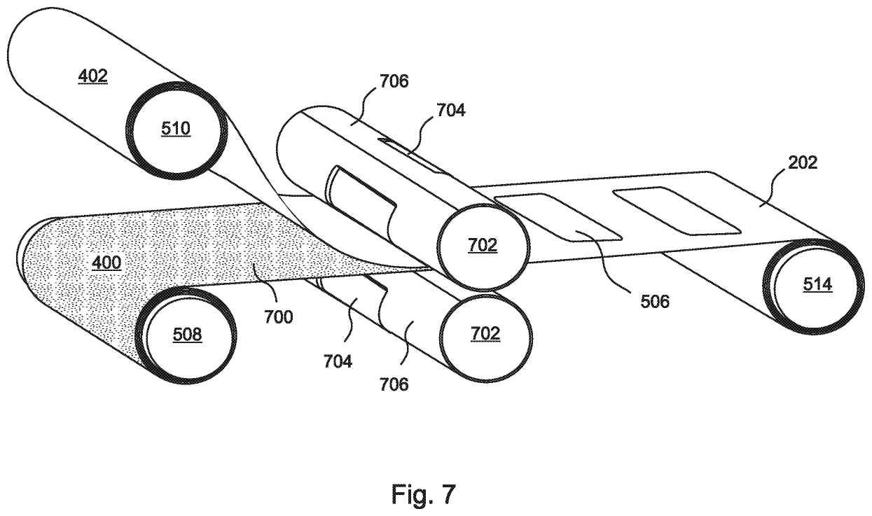

With reference to FIG. 7, in still other embodiments, a pressure and/or heat sensitive adhesive 700 is applied uniformly to one of the film layers, after which the layers 400, 402 are pressed together by a pair of roller assemblies 702 that include corresponding inset and/or unheated regions 704. In the embodiment of FIG. 7, the roller assemblies 702 are conventional rollers that are surrounded by magnetically attached plates 706 having insets 704. As a result, the film layers 400, 402 are not bonded to each other in the regions 506 that pass between the inset and/or unheated regions 704, thereby creating the required window areas 506. It should be noted that these embodiments require that the adhesive used must not interfere with the moisture transfer rate of the second film layer.

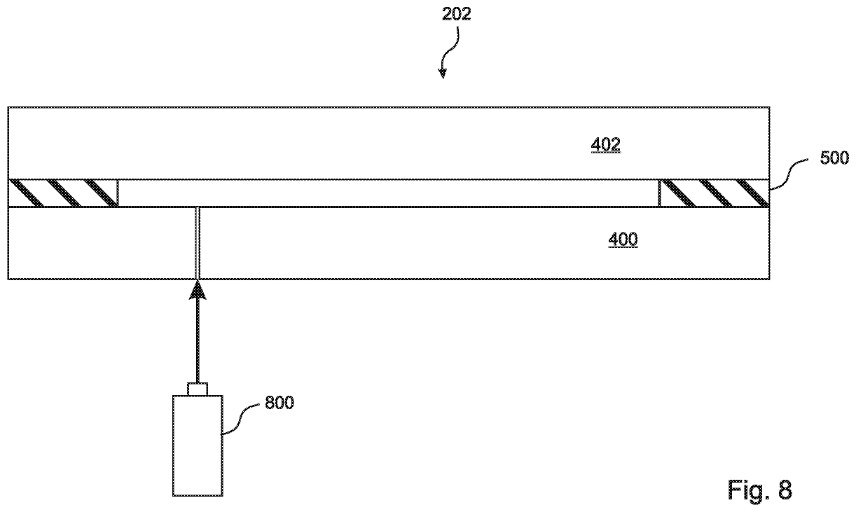

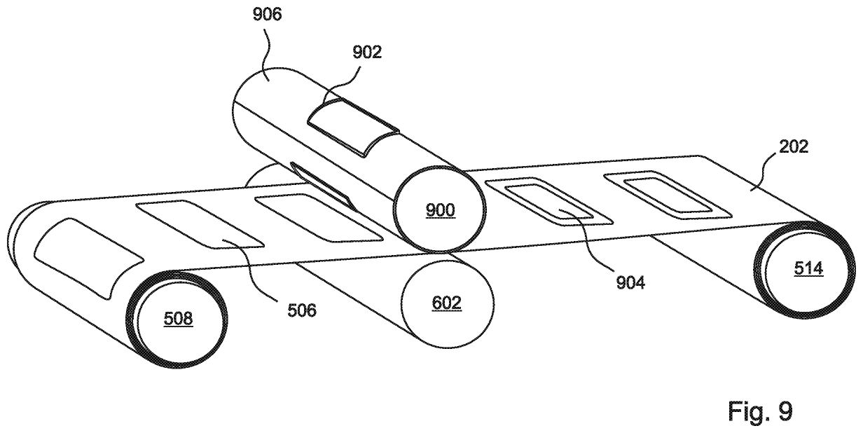

With reference to FIG. 8-10B, after the two film layers 400, 402 have been laminated together, a device such as a laser 800 or a mechanical die-cutting plate or roller assembly 900 is used to cut out and remove panels 904 of the first film layer 400 from within the window areas 506, while leaving the second film layer 402 intact throughout the laminate film 202. With reference to FIG. 8, in the case of a laser 800, the laser processing conditions are adjusted such that the beam penetrates through the first film layer 400, but does not fully penetrate the second film layer 402. In the embodiment of FIG. 9, a roller assembly 900 comprises a conventional roller surrounded by a magnetically attached die-cutting plate 906, where the die-cutting edges or blades 902 of the magnetic plate 906 extend above the surface of the magnetic plate 906 far enough to mechanically penetrate through the first film layer 400, but not far enough to penetrate completely through the second film layer 402.

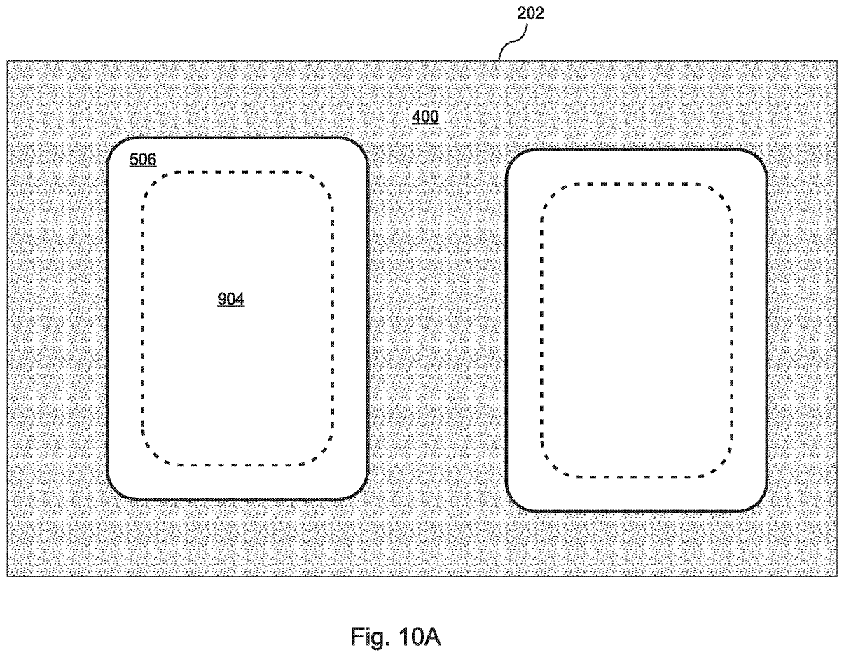

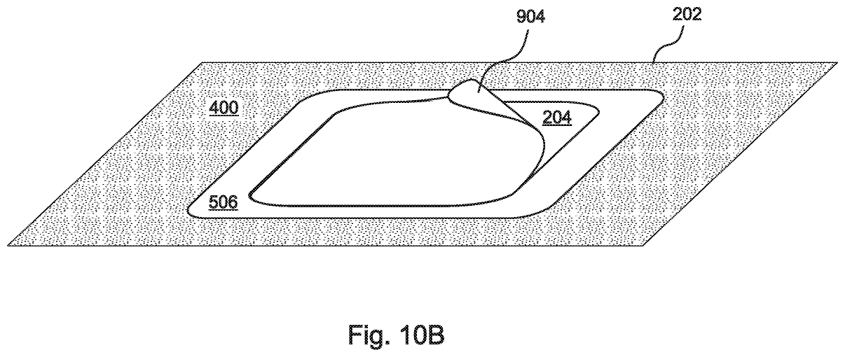

With reference to FIG. 10A, in embodiments the window areas 506 are slightly larger than the cut panels 904, thereby ensuring that no parts of the cut panels 904 are adhered to the second film layer 402. With reference to FIG. 10B, this lack of adhesion allows the cut panels 904 to simply fall away from the laminate film 202, or to be easily pulled away, e.g. by a suction device (not shown).

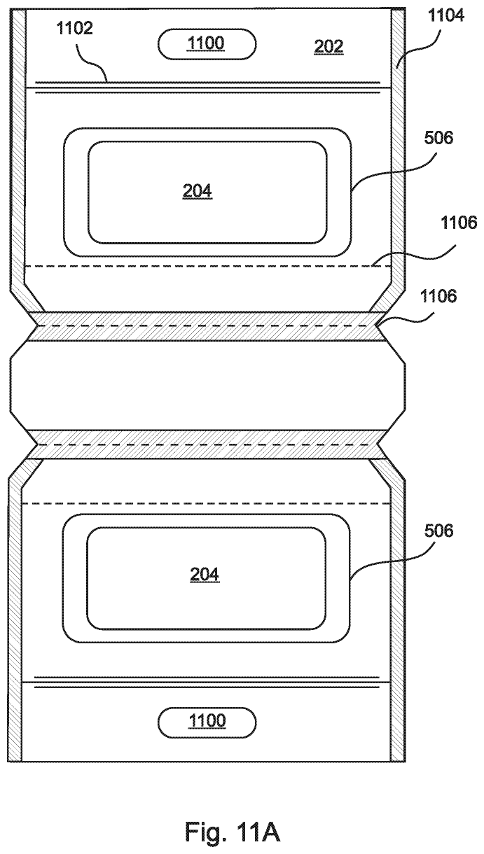

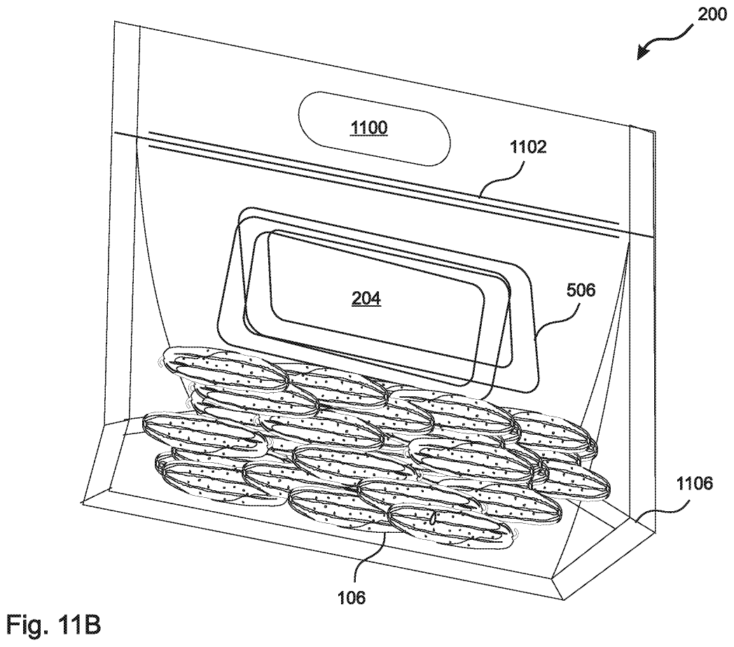

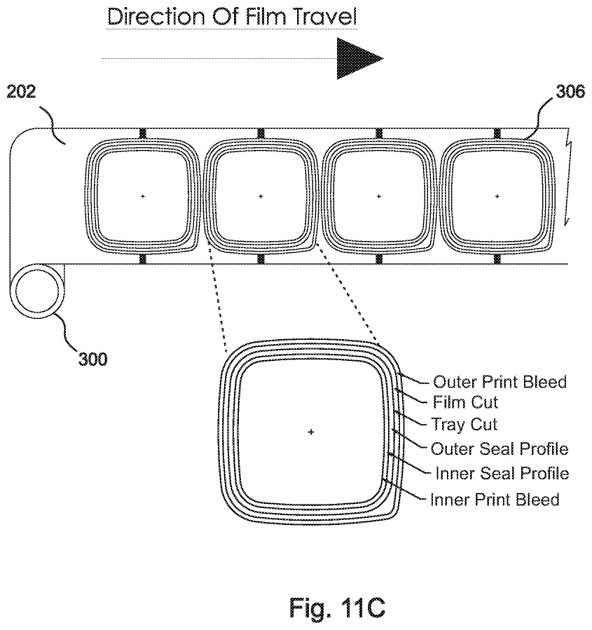

With reference to FIG. 11A, the MCE container of the present invention is then created by cutting out a section of the laminate film in an appropriate size and shape, and bonding selected “seam” regions 1104 of the laminate film 202 to each other, and/or to an underlying rigid or semi-rigid container. In the example of FIGS. 11A and 11B, the first film layer 400 is made from a material such as heat-sealable PET that can be readily heat sealed, and the attachment of the “seams” 1104 of the laminate film is by heat sealing of the first film layers 400 to each other in the seam regions 1104. In these embodiments, it is not necessary that the second film layer 402 be readily heat sealable.

The example of FIGS. 11A and 11B further includes a cut-out opening 1100 that forms a handle, a zipper 1102, and fold lines 1106 that produce a bottom gusset. FIG. 11A illustrates the film 202 as it appears in this example before it is folded and the seams 1104 are formed, while FIG. 11B shows the resulting pouch 200 containing produce 106.

FIG. 11C illustrates a practical example, drawn to scale, of an adhesive pattern used in an embodiment where the laminate film 202 is applied as a lidding film to a tray 302. The adhesive is applied to the laminate film 202 in an adhesive pattern 306 that is configured such that the adhesive will not encroach into any region of the MCE container 300 that is accessible to the contents 106 of the container 300.

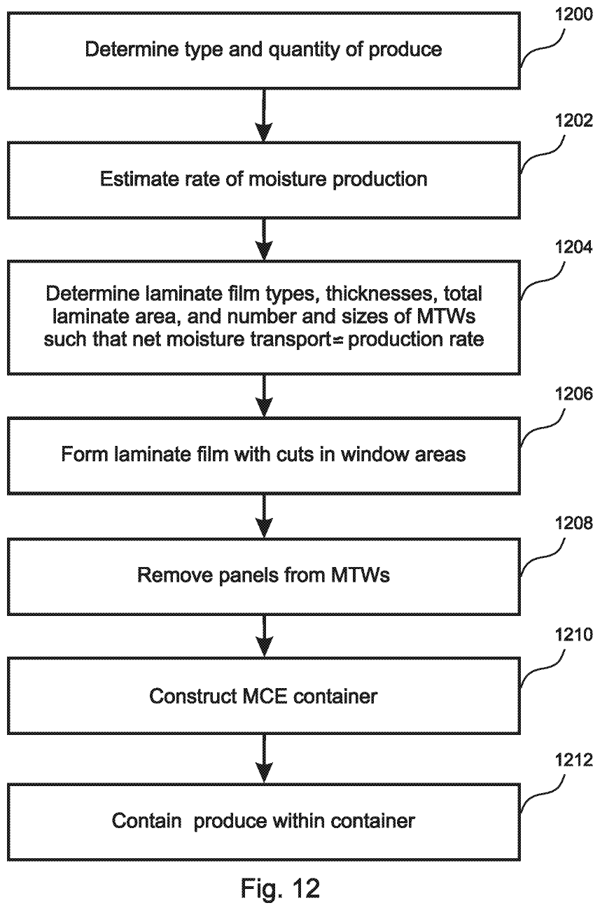

FIG. 12 is a flow diagram that illustrates a method embodiment of the present invention. As a first step, the type and quantity of fresh produce to be contained is determined 1200. Then the rate of moisture production is estimated 1202, and the laminate film is designed, where designing the laminate film includes determining the types and thicknesses of the first and second layers, and determining the number, sizes, and locations of the MTWs 1204.

The laminate film is then prepared by laminating the two layers together and cutting and removing the cut panels from the laminate film to form the MTWs 1206, 1208. Finally, the MCE container is constructed with the laminate film incorporated into at least one wall thereof 1210, and the produce is sealed within the MCE container 1212.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the invention is not limited to just these forms, but is amenable to various changes and modifications. The disclosure presented herein does not explicitly disclose all possible combinations of features that fall within the scope of the invention. The features disclosed herein for the various embodiments can generally be interchanged and combined into any combinations that are not self-contradictory without departing from the scope of the invention. In particular, the limitations presented in dependent claims below can be combined with their corresponding independent claims in any number and in any order without departing from the scope of this disclosure, unless the dependent claims are logically incompatible with each other.

I claim:

1. A method for containing a determined type and quantity of fresh produce, the method comprising:
estimating a rate of moisture production of the determined type and quantity of the fresh produce at a storage temperature that is not more than 25 °C;
designing a moisture-controlled environment (MCE) container for which a net rate of moisture transport from the MCE container to a surrounding environment will be substantially equal to the estimated rate of moisture production of the determined type and quantity of the fresh produce when the MCE container and the determined type and quantity of the fresh produce are at the storage temperature;
constructing the designed MCE container; and
containing the determined type and quantity of the fresh produce in the constructed MCE container;
wherein:
at least one wall of the MCE container comprises a laminate film;
the laminate film comprises a first film layer having a water vapor transport rate “WVTR” which is not more than 70g-mil/m2 -day @38 C and 100% RH;
the laminate film further comprises a second film layer laminated to the first film layer, the second film layer having an O₂ transfer rate that is not more than 70 cc-mil O₂/m² day at 23 °C and 0% RH, and a WVTR that is between 250 and 700 g-mil/m²-day at 38 °C and 100% RH;
the laminate film comprises at least one moisture transport window (MTW) in which only the second film layer is present, while the first film layer is absent;
designing the MCE container comprises determining a number and associated sizes of the MTWs that will cause the net rate of moisture transport from the MCE container to the surrounding environment to be substantially equal to the estimated rate of moisture production of the determined type and quantity of the fresh produce when the MCE container and the fresh produce are at the storage temperature;
each of the MTWs occupies at least 1% of a total area of the laminate film; and
a combined area of all of the MTWs occupies between 10% and 90% of the total area of the laminate film; and
constructing the MCE container comprises preparing the laminate film, including the at least one MTW, before incorporation thereof into the MCE container.

2. The method of claim 1, wherein the first film layer is a layer of heat-sealable polyethylene terephthalate (PET) film.

3. The method of claim 1, wherein the second film layer is a layer of nylon, cellulose, or polylactic acid film.

4. The method of claim 1, wherein the MCE container is constructed by applying the laminate film as a lidding film to an underlying rigid or semi-rigid tray.

5. The method of claim 4, wherein the rigid or semi-rigid tray has a WVTR that is less than 40 g-mil/m²-day at 38 °C and 100% RH.

6. The method of claim 4, wherein the attachment regions of the first film layer are heat sealed to an upper flange of the underlying rigid or semi-rigid tray.

7. The method of claim 1, wherein all of the container walls are formed by the laminate film.

8. The method of claim 7, wherein the container is formed by heat sealing together the first film layer of the laminate film in seam regions of the laminate film.

9. The method of claim 1, further comprising:
determining a desired rate of gas exchange through the laminate film; and
providing one or more microperforations of the laminate film, the microperforations being configured such that a modified gaseous atmosphere is established within the MCE container.

10. The method of claim 1, wherein preparing the laminate film, including the at least one MTW, comprises:
including at least one window area in the laminate film within which the first and second film layers are not bonded to each other;
for each of the window areas, forming a cut through the first film layer that defines and surrounds a removable panel of the first film layer that is entirely within the window area, wherein forming the cut comprises directing a cutting device at the first film layer of the laminate film, the cutting device being configured to cut through the first film layer but not to cut completely through the second film layer; and
for each of the window areas, removing the removable panel from the window area, thereby forming one of the at least one MTWs.

11. The method of claim 10, wherein:
preparing the laminate film comprises applying an adhesive to an adhesive-applying roller assembly having at least one inset;
applying the adhesive-applying roller assembly to one of the first film layer and the second film layer before lamination together thereof, the adhesive not being applied to the at least one window area; and
applying the first film layer to the second film layer, thereby causing the applied adhesive to bond together the first and second film layers to form the laminate film.

12. The method of claim 10, wherein preparing the laminate film comprises:
spraying an adhesive through a mask positioned above the first film layer or the second film layer before lamination together thereof, whereby the mask prevents the adhesive from being applied to the at least one window area; and
applying the first film layer to the second film layer, thereby forming the laminate film causing the applied adhesive to bond together the first and second film layers except in the at least one window area.

13. The method of claim 10, wherein preparing the laminate film comprises:
applying a pressure-activated adhesive uniformly to at least one of the first film layer and the second film layer before lamination together thereof;
mutually aligning the first film layer with the second film layer; and
applying pressure to the aligned first and second film layers by passing the aligned first and second film layers between a pair of laminating roller assemblies, said laminating roller assemblies having insets that are configured not to apply the pressure to the window areas of the aligned first and second film layers.

14. The method of claim 10, wherein preparing the laminate film comprises:
applying a heat-activated adhesive uniformly to at least one of the first film layer and the second film layer before lamination together thereof;
mutually aligning the first film layer with the second film layer; and
applying heat to the aligned first and second film layers by passing the aligned first and second film layers between a pair of laminating roller assemblies, said laminating roller assemblies having unheated regions that are configured not to apply the heat to the window areas of the aligned first and second film layers.

15. The method of claim 10, wherein for each of the window areas, the cutting device is a laser.

16. The method of claim 10, wherein for each of the window areas, the cutting device is a mechanical die-cutting plate.

17. The method of claim 10, wherein for each of the window areas, the cutting device is a mechanical die-cutting roller assembly.

18. The method of claim 17, wherein the roller assembly comprises a conventional roller surrounded by a magnetically attached die-cutting plate.

19. The method of claim 10, wherein for each of the window areas, the removable panel is removed at least partly by gravitational force.

20. The method of claim 10, wherein for each of the window areas, the removable panel is removed at least partly by application of suction thereto.
